(19) United States
(12) Patent Application Publication
(10) Pub. No.: US 2015/0353335 A1
(43) Pub. Date: Dec. 10, 2015

(54) Beverage Dispenser and Related Methods

(71) Applicant: Sprizzi Drink Co., La Jolla, CA (US)

(72) Inventor: MICHAEL JOHN BREAULT, REDLANDS, CA (US)

(73) Assignee: SPRIZZI DRINK CO., La Jolla, CA (US)

(21) Appl. No.: 14/736,201

(22) Filed: Jun. 10, 2015

Related U.S. Application Data
(60) Provisional application No. 62/010,422, filed on Jun. 10, 2014.

(51) Int. Cl. B67D 1/00

(52) U.S. Cl. CPC B67D 1/0021; B67D 1/0057

(57) ABSTRACT

The present invention relates to a beverage dispenser configured to dispense variable serving sizes of cold beverages. The dispenser can dispense both carbonated and non-carbonated beverages. The dispenser includes a mechanism to carbonate water and can be used with a variety of different syrup flavors.

### CROSS-REFERENCE TO RELATED APPLICATIONS

This application claims the priority and benefit of U.S. Provisional Patent Application No. 62/010,422 entitled “Beverage Dispenser and Related Methods” filed Jun. 10, 2014, which is hereby incorporated by reference in its entirety as if fully set forth herein.

### STATEMENT REGARDING FEDERALLY SPONSORED RESEARCH OR DEVELOPMENT

Not applicable.

### BACKGROUND OF INVENTION

1. Field of the Invention

The disclosed subject matter is in the field of beverage dispensers.

2. Background of the Invention

A beverage is a liquid drink for human consumption. Beverage varieties include, but are not limited to: water, alcoholic drinks, non-alcoholic drinks, carbonated drinks, fruit or vegetable juice, and hot drinks (e.g., coffee, tea, and hot chocolate). Beverages of any variety are consumed by the general population on a daily basis.

Beverages, other than water, frequently involve complicated or lengthy preparations. As a result, large quantities of premade beverages are frequently canned or bottled for later consumption. Consuming canned or bottled beverages can be problematic. For instance, bottled or canned beverages, once opened, must be consumed within a relatively short period to avoid spoliation of the beverage (e.g., the flattening of a carbonated soda). Also, bottled or canned beverages can result in waste, particularly in the case of aluminum cans and plastic bottles. Finally, canned and bottled soda typically lacks the freshness of soda dispensed from a soda fountain.

To avoid spoliation and to adjust serving sizes, sometimes beverages are dispensed from a dispenser that mixes a concentrate flavoring, or syrup, with a base fluid like water. For instance, traditional soda fountains and dispensers have been in existence for years and use bag-in-box (BIB) pumps to deliver syrups to a mix system. The traditional systems mix the beverage components (i.e. carbon dioxide, water, or syrup) via motors and contain numerous moving parts. Additionally, these dispensers are too large and expensive to be practical for home use. Instead, soda dispensers are mostly used commercially in establishments like restaurants, bars, and convenience stores.

Recently, there have been some developments in beverage makers or dispensers for home use. For instance, sodastream is a machine that allows a user to mix carbonated beverages at home. To use the sodastream, a reusable 1 L bottle that is only compatible with sodastream is placed into a pump so that carbon dioxide may be pumped into the water. Later, the carbonated water can be mixed with syrup to make a carbonated beverage. One downside of sodastream is that it does not create single servings of carbonated beverages. It must be mixed in 1 L batches, and not variable single servings. Another downside of the sodastream is that the user manually measures and mixes the syrup and carbonated water, which can lead to inconsistent flavors if a user adds too much or too little syrup.

While there is very little in the area of at home single serving carbonated beverage dispensers, there are several products available for making single servings of hot, noncarbonated beverages. Products like Keurig® and Nesspresso® allow a user to brew a single cup of coffee or other hot beverage. To use one of these devices, a user places a premeasured disposable cup of coffee grounds, dried tea, or another hot beverage mix in the machine. The machine then introduces a predetermined amount of hot water through the cup to “brew” the beverage. The machine then dispenses the hot drink. Because both the coffee and the water are premeasured, the single cup coffee makers will only make hot drinks in discreet sizes.

Most recently Santoiemmo (U.S. Pat. No. 8,250,972) taught a device that can dispense single servings of carbonated beverages. Santoiemmo's device works similar to single serve coffee machines—it uses premeasured amounts of syrup and mixes it with a predetermined amount of water. Santoiemmo's device mixes soda in a machine, but it can only do so in discrete serving sizes. For example, Santoiemmo's device might have three possible settings, such as 6 oz, 12 oz, and 16 oz. If the machine had only those three settings, a user would be unable to dispense a 10 oz drink.

In view of the foregoing, a need exists to create a machine that dispenses cold beverages of variable sizes but on a small scale suitable for home use.

### SUMMARY OF THE INVENTION

It is an object of the present invention to provide a dispenser of carbonated drinks that is small enough for at home use.

It is another object of the present application to dispense carbonated drinks in variable serving sizes.

It is another object of the present invention to dispense non-carbonated drinks, in addition to carbonated sodas.

It is another object of the present invention to dispense cold, chilled drinks in variable quantities and with consistent flavor.

In one embodiment, disclosed is a beverage dispenser capable of making and dispensing cold beverages comprising: a water source; a chiller; a flavor port; a flavor injector; and a discharge port for dispensing the beverage. Suitably, the water source may be a live water line, and the chiller may be a thermoelectric chiller. For carbonated beverages, the dispenser may further comprise a carbon dioxide port.

### BRIEF DESCRIPTION OF THE FIGURES

The manner in which these objectives and other desirable characteristics can be obtained is explained in the following description and attached figures in which:

FIG. 1 is a perspective view of the soft drink dispenser.

FIG. 2 is a perspective view of a flavor bullet.

FIG. 3 is a front view of a flavor bullet.

FIG. 4 is a front view of a flavor bullet dispensing syrup.

FIG. 5 is perspective view of a flavor injector inside the dispenser.

FIG. 6 is a see through perspective view of the flavor injector showing the interior components.

FIG. 7 is a zoom-in perspective view of a flavor port.

FIG. 8 is a rear perspective view of the dispenser.

FIG. 9 is a perspective view of a carbon dioxide canister for the dispenser of FIG. 1.

FIG. 10 is an interior view that shows how the flavor injector and the flavor bullet interact.

FIG. 11 is a diagram that shows the preferable method of mixing carbon dioxide and water.

### DETAILED DESCRIPTION OF THE INVENTION

Disclosed is a beverage dispenser capable of making and dispensing cold beverages comprising: a water source; a chiller; a flavor port; a flavor injector; and a discharge port for dispensing the beverage. Further disclosed, is a method of making a beverage in a beverage maker comprising: chilling water in a water source; pumping the water the past the outlet of a flavor injector; and, dispensing the water. The specific details are disclosed with reference to attached figures.

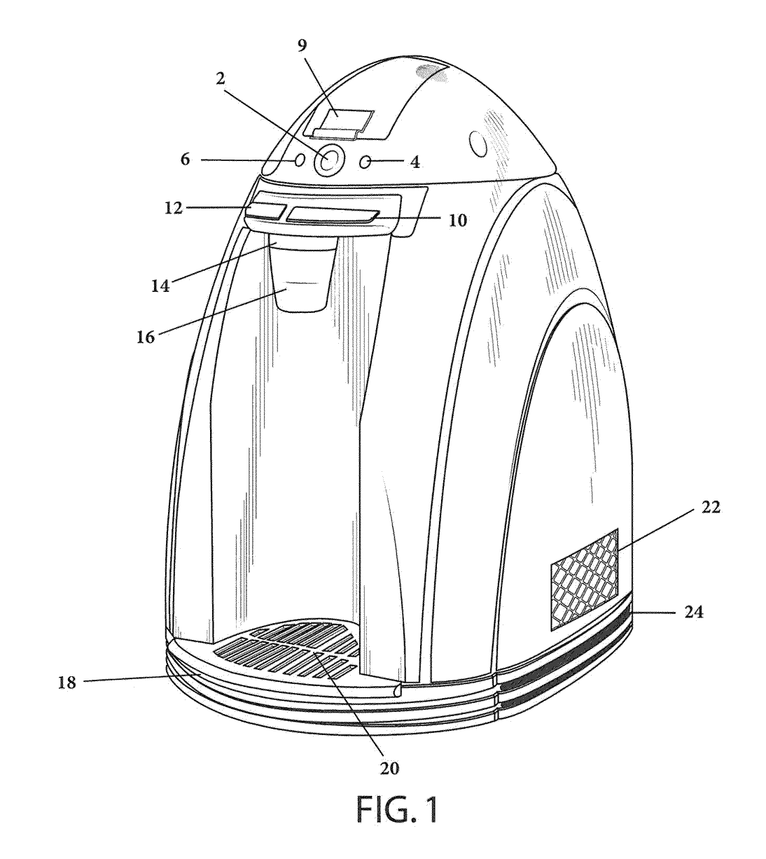

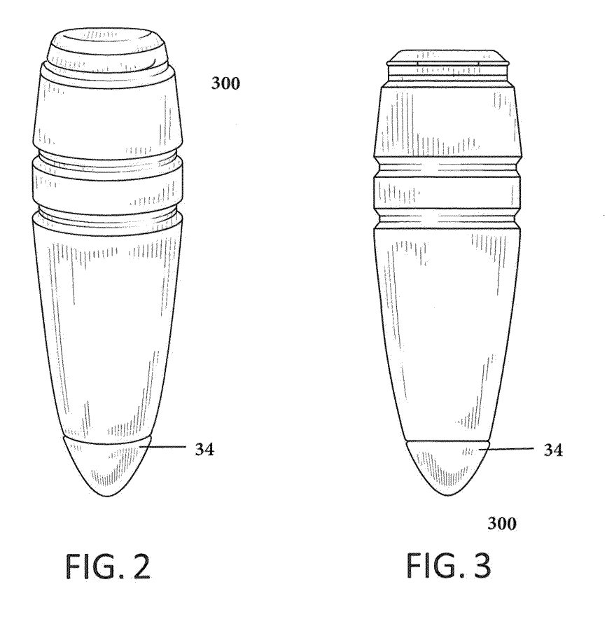

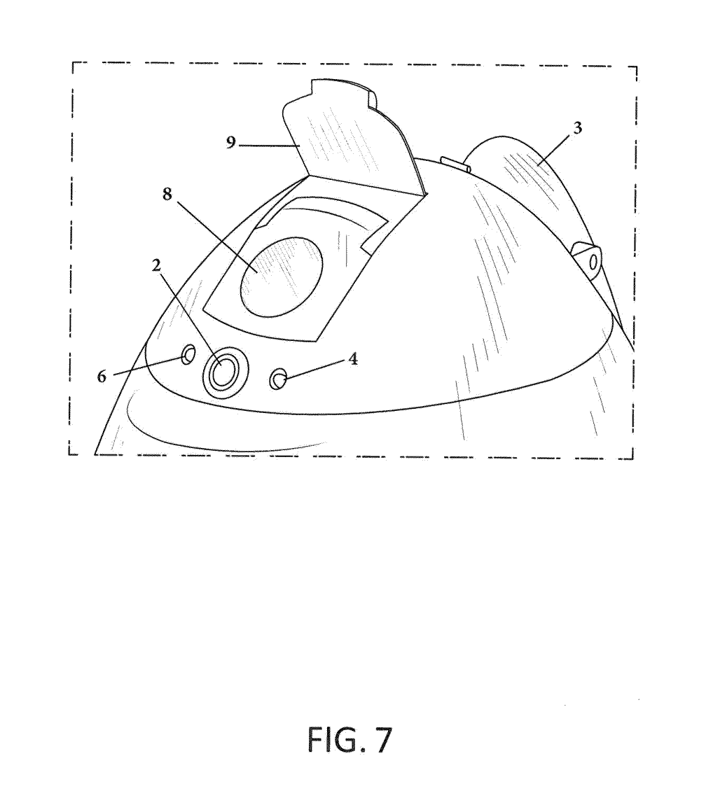

FIG. 1 is a front perspective view of the preferred embodiment of the drink dispenser machine as it is assembled for use. In this particular embodiment, the machine features a parabolic-type shape. The exterior of the machine can be made of durable plastic capable of withstanding hot or cold temperatures. When using the dispenser, a user turns the machine on and off with the power button 2. The power button is usually located near the top of the machine in the center. On either side of the power button are two lights. The carbon dioxide light 4 is suitably located on the right of the power button 2. The carbon dioxide light 4 turns red when the machine needs a refill of carbon dioxide. On the left of the power button 2 is a water light 6. The water light 6 will turn red when the machine needs a refill of water. Just above the power button 2 is the door 9 to the flavor port 8 (see FIG. 7). The flavor port 8 opens and closes so that the user can insert a flavor bullet 300 (see FIG. 2) inside of the drink dispenser. The flavor bullet 300 (see FIG. 2) contains a concentrated drink mix that will blend with either still water or soda water to create a beverage.

Still referring to FIG. 1, underneath the power button 2 and lights are two additional buttons. The soda water dispensing button 10 is located on the right. When the soda water dispensing button 10 is pushed, the machine will dispense a carbonated beverage in a steady stream. If there is no flavor bullet 300 inserted in the flavor port 8, then the machine will dispense just soda water, as long as the door 9 to the flavor port 8 is closed. If there is a flavor bullet in the flavor port 8, then the machine will dispense a flavored, carbonated beverage of choice. While the soda water dispensing button 10 is being pressed, the machine will continue to dispense the beverage. This allows a user to choose the serving size he or she wishes to consume. By pressing the soda dispensing button 10 for a short time, the machine will dispense a small amount of beverage. If a user presses the soda dispensing button 10 for a longer period of time, then the machine will dispense a larger serving of beverage.

To the left of the soda water dispensing button 10, is the water dispensing button 12. When a user pushes the water dispensing button 12, the machine will dispense non-carbonated water if there is no flavor bullet in the flavor port 8. If there is a flavor bullet in the flavor port 8, then the machine will dispense a non-carbonated drink, such as juice or a sports drink. The water dispensing button 12 typically works like the soda dispensing button 10. A user can choose the serving size based on the length of time he or she holds down on the water dispensing button 12.

Still looking at FIG. 1, when the drink dispenser dispenses a beverage, the contents, i.e. syrup and water, flow through the flavor diffuser 14. The diffuser 14 aids in mixing the syrup and water by slowing down the flow of the liquids. The diffuser 14 may be a commercially available product or it may be a diffuser 14 specially fitted to accompany the present invention. The diffuser 14 aids in making the taste of the beverages consistent. The diffuser 14 is made of a dishwasher safe plastic and can be easily washed to maintain a consistent quality to the drinks. Once the drink has been mixed in the diffuser 14, the drink will be dispensed through the nozzle 16. The nozzle 16 will also be made of a dishwasher safe material and is capable of being removed and replaced.

FIG. 1 shows the base of the machine, there is a drip tray 18 and a splash guard 20. The drip tray 18 is a shallow container at the base of the machine. The drip tray 18 can trap liquid that inadvertently drips from the nozzle 16. A splash guard 20 covers the top of the drip tray 18. The splash guard 20 has a grill like surface that allows liquids to trickle into the drip tray 18. The splash guard 20 minimizes splash that might occur from an accidental spill. Both the drip tray 18 and the splash guard 20 are removable and made of a dishwasher safe material.

The drinks that are dispensed from the machine are preferably cold by virtue of a thermoelectric chiller 22. The thermoelectric chiller 22 works by having current flow through two conductors. The thermoelectric chiller 22 uses thermoelectric technology to chill the temperature of the water so that drinks dispensed from the machine are at a cool temperature as if they had just come out of a refrigerator. When current flows through two different conductors, heat can be generated or removed at the junction point. A thermoelectric mechanism creates a hot sink and a cold sink and heat can be extracted away from the chiller using a fan. The cold sink lowers the temperature of the water. This is similar to technology found in dispensers that dispense cold filtered water. When the power to the machine described in the present invention is turned on, the thermoelectric chiller 22 will begin to chill water stored in the machine. If the user choses to connect the machine to a live water line, then the thermoelectric technology will work in a similar manner to filtered water dispenser.

Looking at FIG. 1, just below the thermoelectric cooler 22 is a light 24. In this embodiment, the two strips just below the cooler light up when the machine is turned on. The light 24 provides illumination if the lighting is minimal. The machine can also be made without the light 24. In the preferred embodiment, if the user holds down on the power button 2 for five seconds, the light 24 will dim to 50% capacity and if the user holds down the power button 2 for ten seconds the light 24 will turn off while the machine will remain on. In one embodiment, the machine will automatically turn off after a period of inactivity. However, the refrigeration will remain on as long as the machine is plugged in.

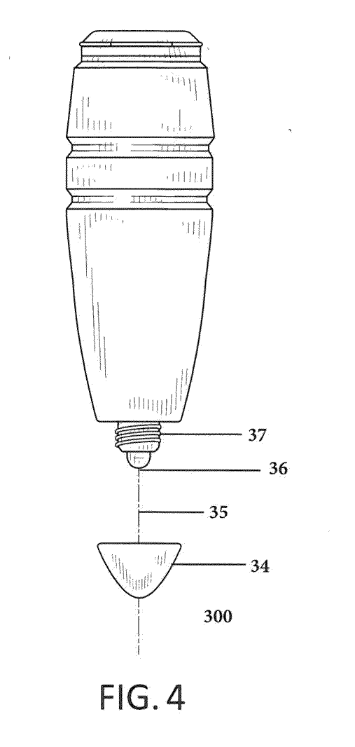

FIG. 2 is a perspective view of a flavor bullet 300. The flavor bullet 300 is a sleek plastic container that contains syrup. The syrup can come in many different flavors such as cola, lemon-lime, root beer, and ginger ale, among others. In this embodiment, for example, the flavor bullet 300 might contain two ounces of syrup. At the bottom of the flavor bullet 300 is a cap 34. The cap 34 covers a hole 36 (see FIG. 4) at the bottom of the flavor bullet 300.

FIG. 3 shows front view of a preferable flavor bullet.

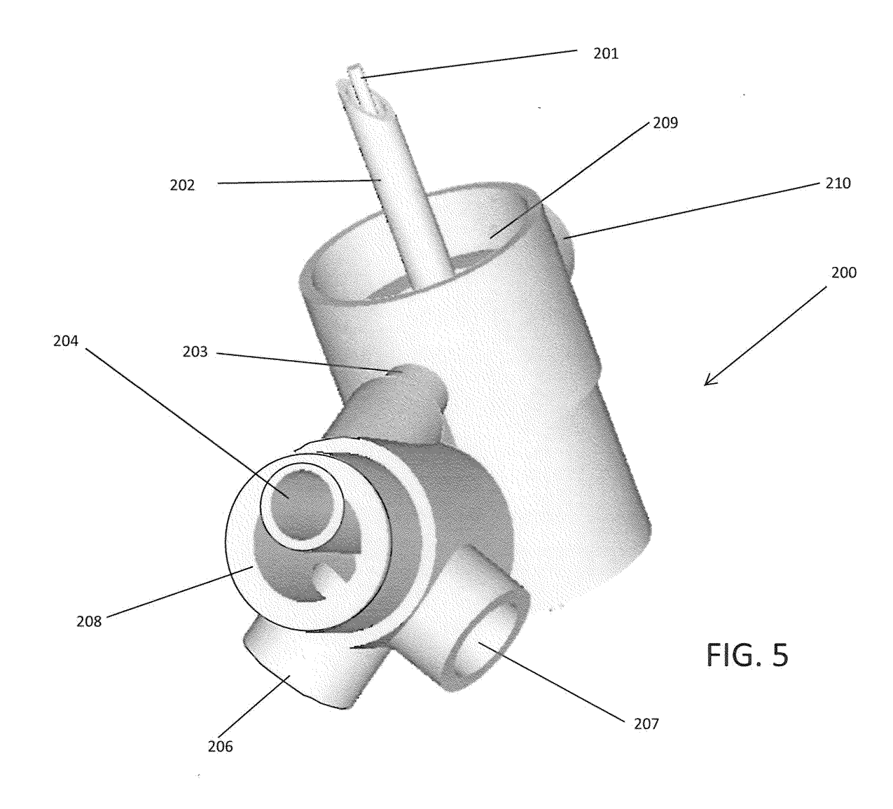

FIG. 4 shows a flavor bullet 300 dispensing syrup 35. There is a single opening in the flavor bullet 300, which is a hole 36 at the bottom. When the flavor bullet 300 is inserted into the machine, the pressure injector 200 (see FIG. 5) fits into the hole 36. When the flavor bullet 300 is in the machine, syrup will flow out of the hole 36 into the flavor injector 200 (see FIG. 5). In an alternate embodiment (not shown), the flavor bullet 300 features at least one hole to the side of the central hole 36 that allows for faster syrup flow. The flavor bullet 300 also features a threaded section 37 which allows a user to screw the flavor bullet 300 into a drink machine so that it fits snugly, ensuring consistent suction.

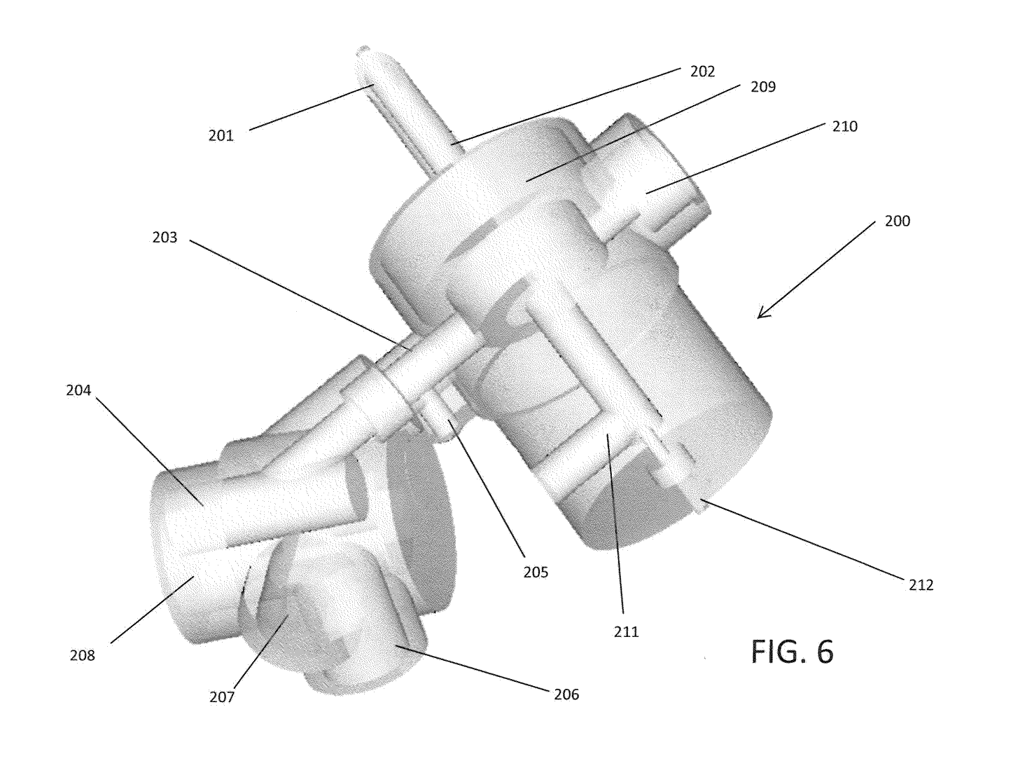

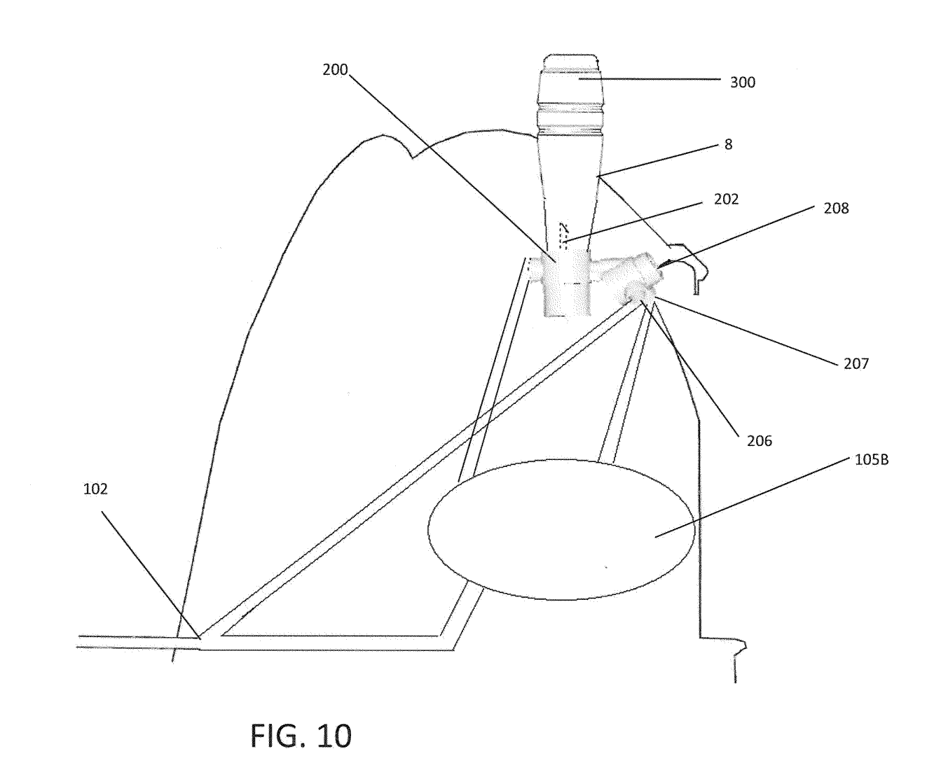

FIG. 5 is a perspective view of a flavor injector 200 and FIG. 6 is a perspective view showing the interior of the flavor injector 200. The flavor injector 200 is an interior component of the machine (see FIG. 10). The flavor injector 200 is used for injecting syrup into a stream of water at a premeasured ratio. The flavor injector 200 features a syrup sensing rod 201. The syrup sensing rod 201 is preferably constructed from tungsten or tungsten steel, but may be made from another type of metal or a sturdy polymer. When a flavor bullet 300 is inserted into the dispenser, the flavor bullet will fit snugly over the top of the syrup sensing rod 201. The syrup sensing rod 201 is connected to a wire 212, which electronically monitors the syrup level in the flavor bullet 300. The syrup sensing rod 201 is housed inside of a pressure injector 202. The pressure injector 202 is preferably made from Teflon®. The flavor bullet 300 which is insertably placed down onto and over the syrup sensing rod 201 and pressure injector 202. The pressure injector 202 pumps air from a tube 211 into the flavor bullet 300. The air increases the pressure inside of the flavor bullet, forcing the syrup into a reservoir 209. From the reservoir 209, the syrup travels to the syrup inlet 203. The syrup then travels out of the syrup outlet 204. Once the syrup travels out of the syrup outlet 204, it will be mixed with either still water or carbonated water in the beverage outlet 208. In the syrup inlet 203, there is a syrup sensing screw 205. The syrup sensing screw 205 works in conjunction with the syrup sensing rod 201. Both syrup sensors electronically detect when there is no more syrup in the flavor bullet and the reservoir 209, at which point the dispenser will shut down the flow of water out of the nozzle 16. When the flavor bullet 300 runs out of syrup, the water flow will stop until the cartridge 300 is replaced or the door 9 to the flavor port 8 is closed.

The flavor injector 200 features two openings beneath the beverage outlet 208, a still water inlet 206 and a carbonated water inlet 207. When a non-carbonated drink is selected by the user, water will enter the flavor injector 200 via the still water inlet 206. Ultimately, the water enters the beverage outlet 208 where it is mixed with syrup. From there, the mixed beverage travels to the nozzle 16 where it is dispensed for consumption. When a user selects a carbonated beverage, carbonated water enters the flavor injector 200 via the carbonated water inlet 207. The carbonated water then mixes with syrup in the beverage outlet 208 and then travels to the nozzle 16 where it is dispensed for consumption.

In the preferred embodiment, the flavor injector 200 also features a self-cleaning feature. After each drink has been dispensed, a solenoid valve (not shown) will open and slowly drizzle between six and 10 milliliters of carbonated water into the self-cleaning outlet 210. The carbonated water removes syrup remaining in the reservoir 209, syrup inlet 203, syrup outlet 204, and the beverage outlet 208. This self-cleaning mechanism prevents cross-contamination of different drink flavors.

FIG. 7 is a close up view of the flavor port 8, into which a flavor bullet 300 (see FIG. 3) may be inserted. The figure shows the door 9 to the flavor port 8 open. When the door 9 to the flavor port 8 is open, a flavor bullet 300 (see FIG. 3) can be inserted into the flavor port 8. As discussed later in FIG. 10, the hole 36 in the flavor bullet 300 (see FIG. 3) will line up with the syrup sensing rod 201 in the flavor injector 200.

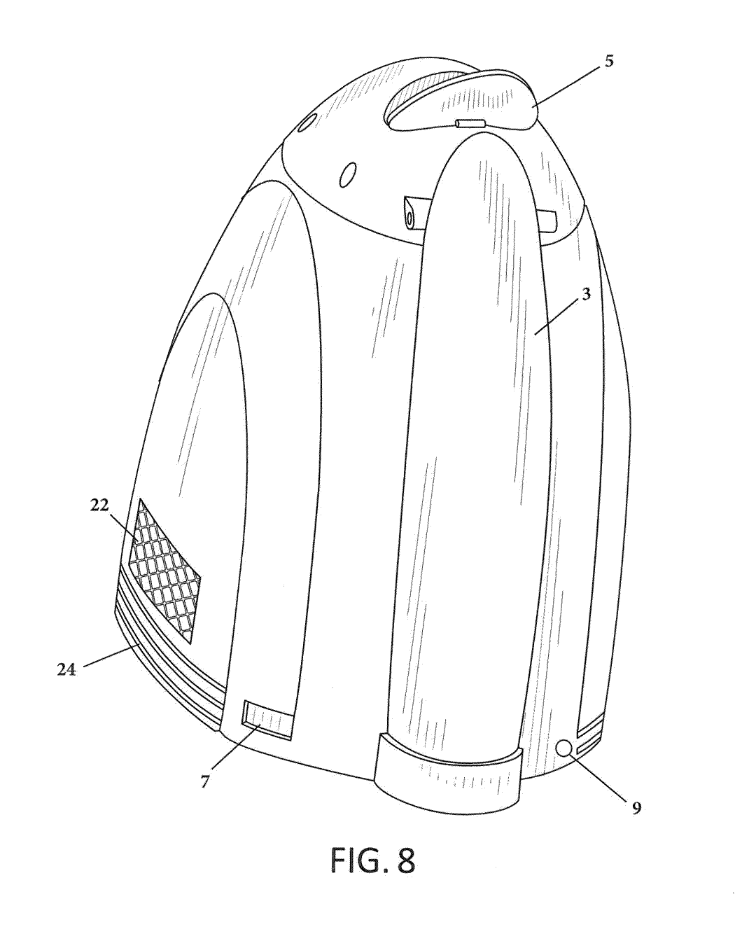

FIG. 8 is a back perspective view of the dispenser. On the bottom left hand side is the plug 7. An AC adapter will connect the drink dispenser to a wall outlet, which will supply power to the dispenser. In the preferred embodiment, the plug 7 will be compatible with commercially available AC adapters.

At the top of the machine is a water access hatch 5. The machine can be supplied with water in one of two ways. Water can be poured directly into the water access hatch 5. In the preferred embodiment of the invention, the drink dispenser holds up to two liters of water. The invention can also be hooked up to a live water line via the water line port 9. In the preferred embodiment, there is a sensor inside of the water storage area that senses when the water level is low and causes the water sensing light 6 to change color in order to alert the user that the water needs to be refilled. Preferably, the water sensor is an electronic probe, but any other type of water level sensor, such as an optical, a float sensor, or a microwave sensor, may be used in conjunction with the machine.

Still referring to FIG. 8, in the back of the machine is a carbon dioxide access door 3. The carbon dioxide access door 3 opens and through the carbon dioxide access door 3, a canister of carbon dioxide can be inserted into the machine. In a preferred embodiment, the user will use screwless carbon dioxide canisters specially configured to work with the drink dispenser, but the drink machine may also be configured to work with small canisters of carbon dioxide that are commercially available. In a preferred embodiment, there is a sensor inside of the carbon dioxide storage area that senses when the carbon dioxide level is low which causes the carbon dioxide sensing light 4 to change color in order to alert the user that the dispenser needs a new canister of carbon dioxide. Preferably, this sensor is a pressure switch that monitors the pressure of the carbon dioxide, but the sensor may be any other type of sensor such as a microwave, infrared, ultrasonic, or capacitance sensor.

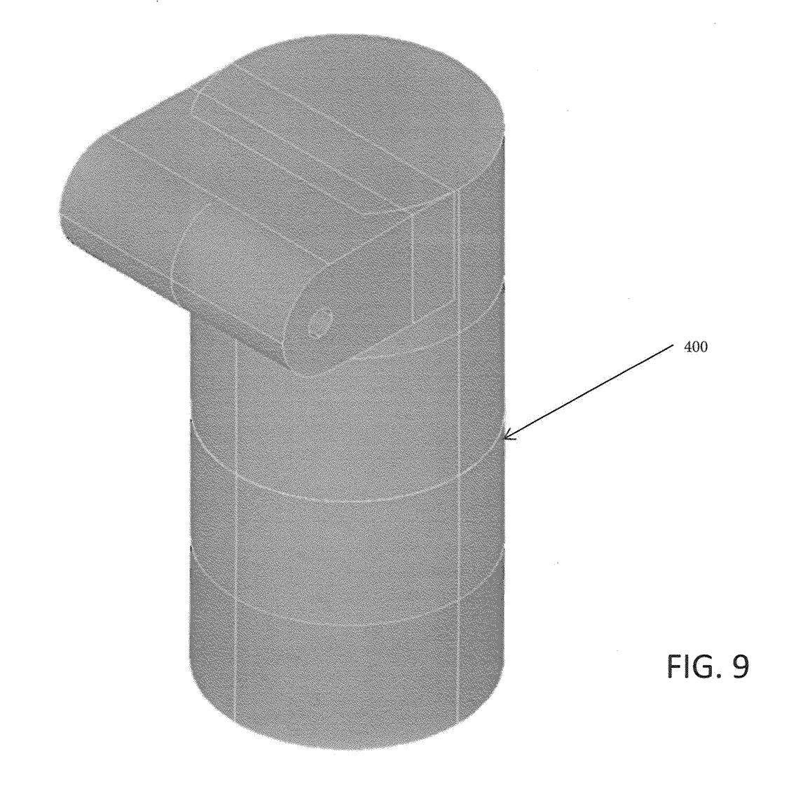

FIG. 9 is a perspective view of a pressure regulator 400 for carbon dioxide of the preferred embodiment of the dispenser. In the preferred embodiment a carbon dioxide source fits inside of the pressure regulator 400, which may be a screwless and threadless device inside of the dispenser.

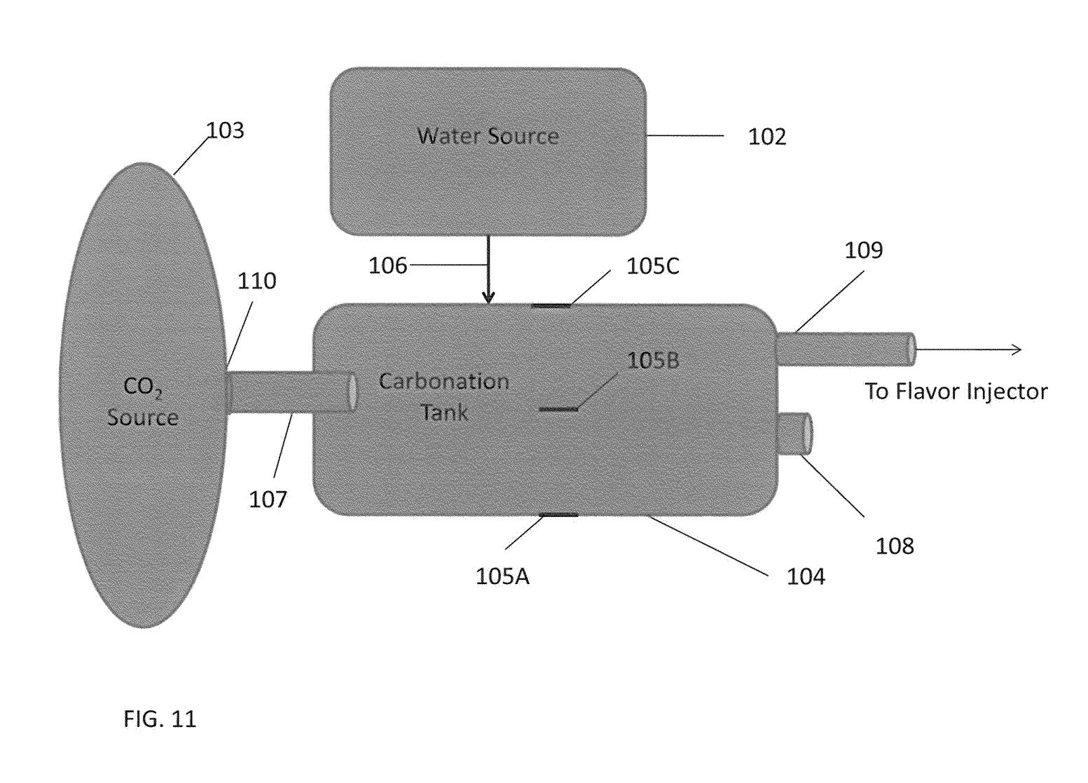

FIG. 10 shows how the flavor injector 200 and the flavor bullet 300 preferably interact inside of the machine. The drawing shows a basic outline of the machine. The drawing shows an approximate location of a carbonation tank 104, although location may vary. The flavor bullet 300 has been inserted into the flavor port 8. The bottom of the flavor bullet 300 sits atop of the flavor injector 200. The syrup sensing rod 201 and pressure injector tube 202 are inside of the flavor bullet 300. The flavor injector 200 is also connected to a water source 102. A water source 102 splits into two channels, one that flows to the carbonation tank 105B and another channel that flows directly to the still water inlet 206 of the flavor injector 200. Water that goes to the carbonation tank 105B will be carbonated. Once the water is carbonated, the water flows out of carbonation tank 104 via solenoid (See FIG. 11) to the carbonated water inlet 207 of the flavor injector 200. Once the water (still or carbonated) and syrup both flow into the flavor injector 200, and the mixed beverage dispenses out the beverage outlet 208. There is a second channel connected to the carbonation tank 104 that connects to the self-cleaning outlet 210 of the flavor injector 200. This drawing does not show all of the details of the inner workings of the invention, it is merely illustrative of how the flavor injector 200 and flavor bullet 300 interact.

When the drink dispenser mixes a carbonated drink, the water will be carbonated before it enters the carbonated water inlet 107 of the flavor injector 100. Water may be carbonated by one of several different methods, preferably mixing water and carbon dioxide in a high pressure tank.

FIG. 11 shows a preferred method for mixing the carbon dioxide and water to create carbonated water. First, water from the water source 102 fills the carbonation tank 104. The carbonation tank 104 has three water level probes 105. When there is enough water in the carbonation tank 104 to reach the top water level probe 105C, the water pump 106 shuts off. After the water pump 106 shuts off, a solenoid 110 from the carbon dioxide source 103 opens, jetting carbon dioxide into the tank 104 via a tapered tube 107. Carbon dioxide will be jetted into the tank 104 in three bursts. The first burst will increase the pressure in the carbonation tank to 120 PSI. The tank 104 exhausts the pressure down to 60 PSI, and after the tank 104 reaches 60 PSI, there will be a second burst to increase the pressure to 120 PSI. The tank 104 will again exhaust to 60 PSI and then there will be a third burst of air to get the tank 104 to a pressure of 120 PSI, where the pressure will remain. After the three bursts, the water travels out of the tank via a dispenser solenoid 109 to the flavor injector 200. As the water leaves the tank 104, the carbon dioxide will continue to enter the tank in order to keep the pressure constant. If water is void from the middle probe 105B, preferably the eight ounce mark, or bottom probe 105A, an exhaust solenoid 108 will open for evacuating excess pressure from the tank and allowing the tank to refill again. When a user has finished pouring a drink, the carbonation system will wait ten seconds before refilling the carbonation tank 104 and creating a new batch of carbonated water. The pressure in the tank is operably kept at 120 PSI. If the tank fills from the middle probe 105B the carbon dioxide will jet for two bursts as opposed to three.

It is to be noted that appended drawings illustrate only typical embodiments of this invention, are not to scale, and therefore not to be considered limiting of its scope, for the invention may admit to other equally effective embodiments which are appreciated by those skilled in the art.

All features disclosed in this specification, including any accompanying claims, abstract, and drawing, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step of” in the clause as specified in 35 U.S.C. §112, paragraph 6 may not be intended as a means plus claim.

This application incorporates by reference U.S. patent application Ser. No. 14/134,309 entitled “Beverage Dispenser and Related Methods.”

I claim:

1. A beverage dispenser comprising:
at least one control to determine a specific type of drink;
a flavor port suitable for receiving a flavor bullet;
a flavor injector that is connected to the flavor port and defined by a first inlet, a second inlet, a syrup outlet, a beverage outlet, a pressure rod, and a sensing rod that receives the flavor bullet;
a carbonation tank connected to the second inlet; and,
a nozzle connected to the beverage outlet, wherein a drink that is mixed in the beverage outlet with water from the first or second inlet and syrup from the syrup outlet is dispensed.
